(19) United States
(12) Patent Application Publication
(10) Pub. No.: US 2013/0145483 A1
(43) Pub. Date: Jun. 6, 2013

(54) System And Method For Processing Protected Electronic Communications

(71) Applicant: JPMorgan Chase Bank, N.A., New York, NY (US)

(72) Inventors: Jeffrey D. DiMuro, Milton, CT (US); David Jude Ford, Warwick, NY (US)

(73) Assignee: JPMORGAN CHASE BANK, N.A., New York, NY (US)

(21) Appl. No.: 13/690,174

(22) Filed: Nov. 30, 2012

Related U.S. Application Data
(60) Provisional application No. 61/566,338, filed on Dec. 2, 2011.

(51) Int. Cl. G06F 21/60

(52) U.S. Cl. CPC G06F 21/60
USPC 726/28

(57) ABSTRACT

Systems and methods for processing protected electronic communications are disclosed. According to one embodiment, a method for processing inbound messages may include (1) receiving a message containing protected content at an electronic device comprising at least one computer processor; (2) using the at least one computer processor, determining a manner in which unprotected content corresponding to the protected content is accessed by a user; and (3) using the at least one computer processor, automatically sending the unprotected content to a first storage location.

### RELATED APPLICATIONS

This patent application is related to U.S. Provisional Patent Application Ser. No. 61/566,338, filed Dec. 2, 2011, the disclosure of which is incorporated by reference in its entirety.

### BACKGROUND OF THE INVENTION

1. Field of the Invention

The present invention generally relates to the processing of protected electronic communications.

2. Description of the Related Art

Inspecting inbound protected messages, such as encrypted/hashed contents received via email, password protected email, etc. presents issues for an organization. Unless an organization fails to take delivery of the encrypted content (e.g., bounce the inbound email before accepting delivery), then the organization may be responsible for retaining and producing the content of the encrypted message when required by state, federal, or country law.

In many cases, the intended recipient is the only party that is able to access the protected or encrypted data. That is because the intended recipient may be the only party in the organization who knows the password required to access the protected content, or is the only party in the organization that maintains the private key needed to decrypt the encrypted data. Until the recipient applies a password, private key, etc. to access the protected data, the organization may not be able to inspect the data for malware, or retain the data in a readable format.

### SUMMARY OF THE INVENTION

Systems and methods for processing protected electronic communications are disclosed. According to one embodiment, a method for processing inbound messages may include (1) receiving a message containing protected content at an electronic device comprising at least one computer processor; (2) using the at least one computer processor, determining a manner in which unprotected content corresponding to the protected content is accessed by a user; and (3) using the at least one computer processor, automatically sending the unprotected content to a first storage location.

The manner in which unprotected content corresponding to the protected content is accessed by a user may be the application of a key, the entry of a password, the entry of a code, the entry of a biometric, etc.

In one embodiment, the first storage location and the second storage location may be the same storage location.

In one embodiment, the method may further include using the at least one computer processor, automatically sending the manner used to access the unprotected content to a second storage location.

In one embodiment, the method may further include using the at least one computer processor, automatically sending the message containing protected content to the first storage location.

According to another embodiment, a method for processing inbound messages may include (1) receiving an inbound message for a recipient; (2) determining, using at least one computer processor, whether the inbound message contains protected content; (3) using the at least one computer processor, marking the inbound message with an indication that the inbound message contains protected content; and (4) sending the marked received message to an electronic device associated with the recipient.

In one embodiment, the step of marking the inbound message may include rewriting envelope information for the inbound message.

In one embodiment, the received message comprises at least one of an email, a file attachment, audio, picture, image, video, text, chat, SMS.

In one embodiment, the method may further include receiving, from the electronic device associated with the intended recipient, a message containing non-protected content corresponding to the protected content; and providing the message containing non-protected content corresponding to the protected content to a first storage location.

In one embodiment, the method may further include providing the inbound message containing protected content to a second storage location.

In one embodiment, the method may further include receiving, from the electronic device associated with the intended recipient, a tool used to access the non-protected content from the protected content; and providing the tool to a third storage location.

In one embodiment, the access tool may be a key, a password, a code, a biometric, etc.

According to another embodiment, a method for processing inbound messages may include (1) receiving an inbound message including protected content; (2) using at least one computer processor, applying a tool to the inbound message to access non-protected content corresponding to the protected content; and (3) providing the non-protected content to a first storage location.

In one embodiment, the method may further include providing the non-protected content to the intended recipient

In one embodiment, the method may further include providing the inbound message to the intended recipient

In one embodiment, the method may further include providing the tool to a second storage location.

In one embodiment, the method may further include providing the received message containing protected content to a third storage location.

In one embodiment, the access tool may be a key, a password, a code, a biometric, etc.

In one embodiment, the tool may be retrieved from a database comprising a plurality of tools.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a schematic of a system for processing inbound protected electronic communications according to one embodiment;

FIG. 2 is a schematic of a system for processing inbound protected electronic communications according to one embodiment;

FIG. 3 is a schematic of a system for processing inbound protected electronic communications according to one embodiment;

FIG. 4 is a flowchart depicting a method for processing inbound protected electronic communications according to one embodiment;

FIG. 5 is a flowchart depicting a method for processing inbound protected electronic communications according to one embodiment;

FIG. 6 is a flowchart depicting a method of processing protected files according to one embodiment; and

FIG. 7 is a flowchart depicting a method for processing outbound messages according to one embodiment.

### DETAILED DESCRIPTION OF PREFERRED EMBODIMENTS

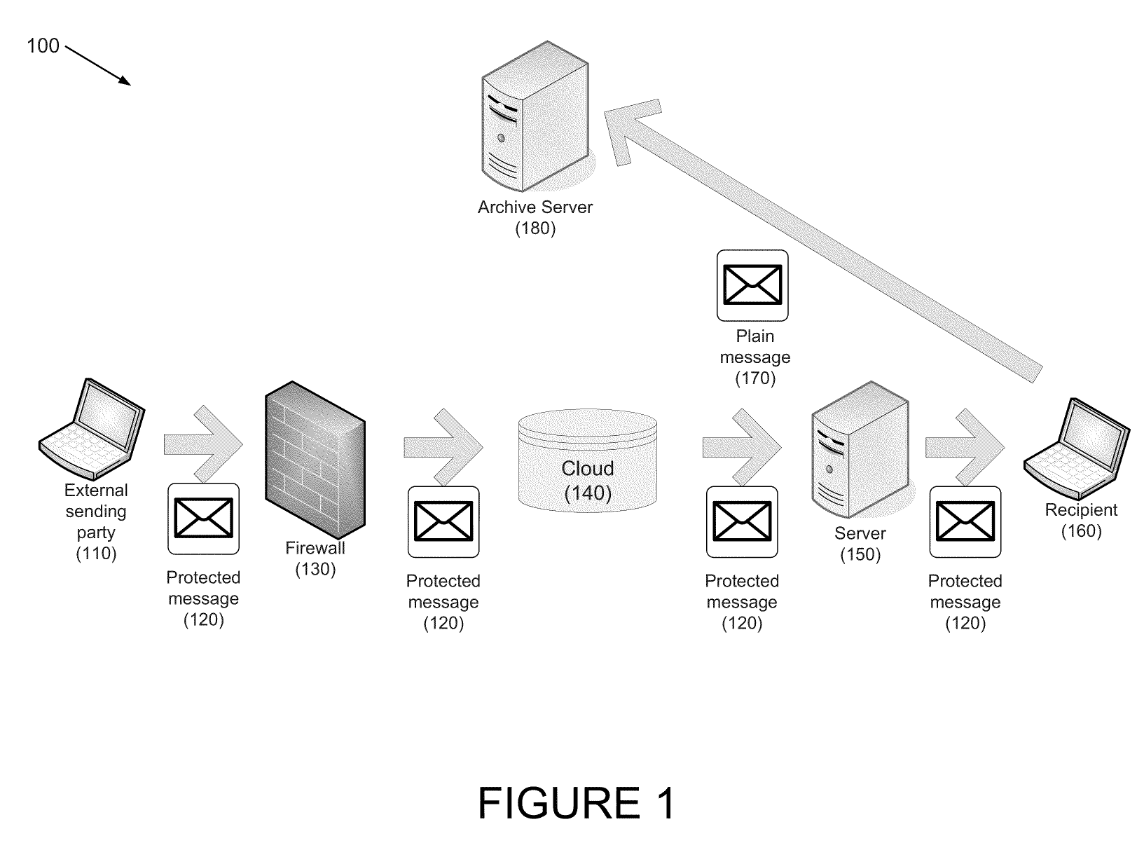

Several embodiments of the present invention and their advantages may be understood by referring to FIGS. 1-7, wherein like reference numerals refer to like elements.

As described herein, a method for processing protected electronic communications is disclosed. In one embodiment, the method may leverage the recipient's action of applying a password, private key, etc. to the protected data, and then may send an copy (exact or otherwise) for inspection and filing in a readable format. In one embodiment, the recipient may be required to access the protected data with the proper password, code, key, biometric, etc. In another embodiment, a database of previously-applied passwords, keys, etc. may be maintained so that an attempt to access protected data may be made in the absence of the intended recipient applying a password, key, biometric, etc. to the protected data.

Thus, in one embodiment, the system and method may apply an agnostic approach. That is, it operates regardless of the method used to protect the message.

Referring to FIG. 1, a system according to one embodiment is disclosed. System 100 may involve external sending party 110 sending protected message 120 to recipient 160. In one embodiment, external sending party 110 may not be part of the same organization as recipient 160. Recipient 160 may be behind a security device such as firewall 130.

Protected message 120 message may be any sort of message that includes data that has been encrypted, secured, scrambled, or otherwise restricted in any manner. For example, protected message 120 may be encrypted using a key. In another embodiment, protected message 120 may be protected with a password or code. In another embodiment, protected message 120 may be protected with a biometric. In another example, protected message 120 may include scrambled and/or encoded text where the intent is to evade inspection or detection.

In one embodiment, only a portion of protected message 120 may be protected. For example, protected message 120 may be an email that is not protected, but may include an attachment that is protected.

In one embodiment, the data that is part of protected message 120 may be any suitable data, including, for example, text, email, a file attachment, a picture, an image, audio, video, chat, SMS, MMS, iMessage, phone, etc.

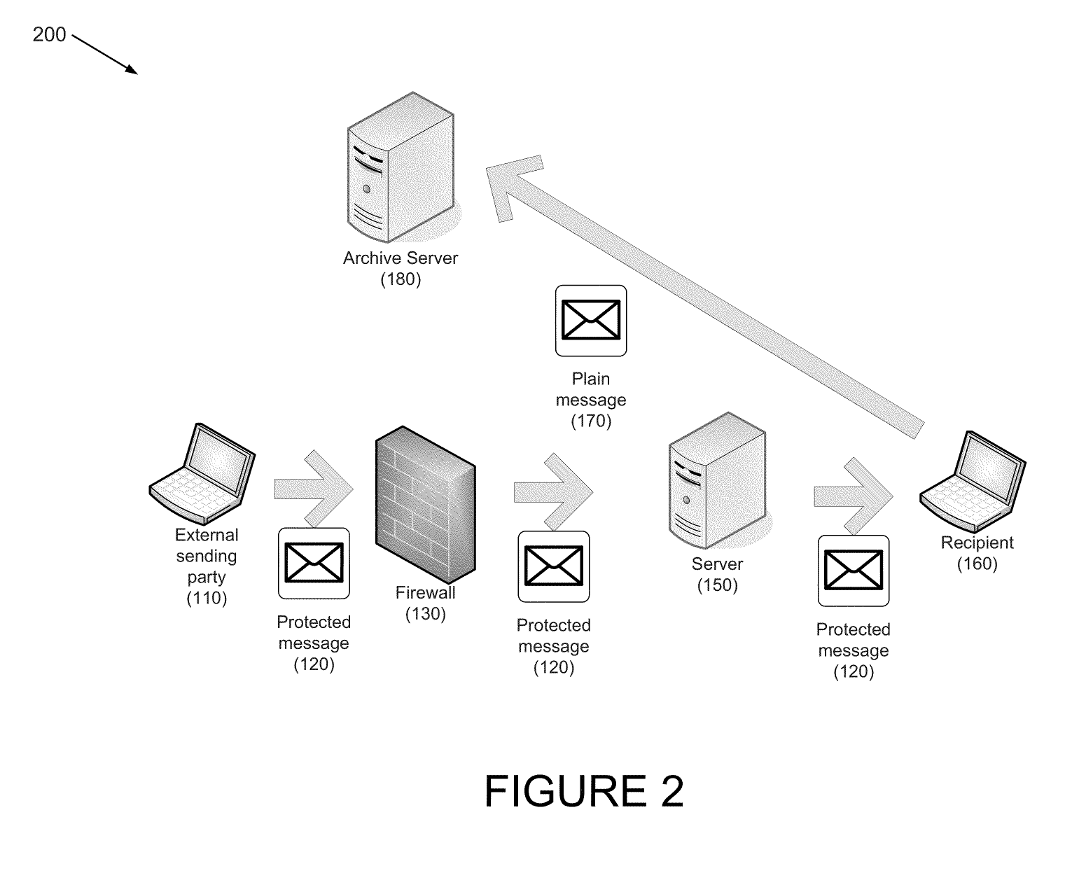

Protected message 120 may pass firewall 130 to cloud storage 140. Cloud storage 140 may be a networked online storage provided by a third party (e.g., Google, Apple, etc.), or it may be an organizational-specific cloud. In another embodiment, depicted in FIG. 2, cloud storage is not used.

In one embodiment, cloud storage 140 may provide a quarantine area (not shown), a “sandbox,” etc. for accessing and/or processing protected message 120.

Protected message 120 may be retrieved from cloud storage 140 through server 150 and then routed to recipient 160.

In one embodiment, server 150 may execute the organization's messaging system and may process the inbound message. Examples of messaging systems include inbound Mail Transfer Agents (MTAs) (e.g., Microsoft Exchange, Lotus Domino/Notes, etc.), cloud-based mail service (Symantec.Cloud, Postini, McAfee, Microsoft, Google, etc.), etc.

In one embodiment, prior to providing protected message 120 to recipient 160, the messaging system may search and/or analyze protected message 120 for protected, encrypted, etc. data by searching for data that is, for example, unreadable. In another embodiment, the messaging system may search message 120 for certain file extensions. In still another embodiment, the messaging system may look for an indication in message 120 that it contains protected data. In still another embodiment, an anti-virus program may detect unreadable or otherwise potentially protected data.

The messaging system may, for example, re-write the message's envelope information to indicate that the message may contain protected data. In another embodiment, the messaging system may mark the message as containing protected data.

In another embodiment, protected message 120 may pass through server 150 and be delivered to recipient 160 without alteration.

Recipient 160 may receive protected message 120 at an electronic device. The electronic device may be any suitable electronic device, including desktop computers, laptop computers, tablet computers, PDAs, smart phones, e-readers, biological computers, organic computers, smart chip devices, smart paper devices, etc. Any device suitable for receiving a protected message may be used.

After accessing the data in protected message 120 by, for example, decrypting the message, entering a password, etc., recipient 160 may send plain message 170, or a copy thereof, to archive server 180 for storage. In another embodiment, protected message 120 may also be sent to archive server 180 for storage. In one embodiment, plain message 170 may be encrypted or otherwise protected and then sent to archive server 180.

In one embodiment, archive server 180 may include a server with storage. In another embodiment, archive server 180 may be a database. In still another embodiment, archive server 180 may simply include storage.

In one embodiment, the data held by archive server 180 may be encrypted.

In one embodiment, as will be discussed below, an application (not shown) executed on recipient 160's device may send plain message 170, or a copy thereof, to archive server 180 for storage. In one embodiment, the key, password, biometric, etc. used to access the message may be sent to archive server 180, or any other suitable location, for storage. This may be in addition to sending plain message 170 to archive server 180, or in place of sending plain message 170 to archive server 180.

In one embodiment, the key or password information may be encrypted or otherwise protected and then sent to archive server 180.

In one embodiment, the application may be a stand-alone application, or it may be part of another application. In another embodiment, the software application may execute in the background and may not require any user intervention. For example, the application may be part of an application that scans attachments for viruses when they are decrypted or otherwise opened, such as a third party application. In another embodiment, the application may be a script executing on recipient 160's device. In still another embodiment, the application may be a part of the operating system executing on recipient 160's device.

In one embodiment, to capture the password, a key-stroke capture agent (or logger) may be used. Thus, as the intended recipient enters the password, code, etc. to access the message, the capture agent would record the keystrokes associated with the password or code. In one embodiment, this may be part of the application executed by recipient 160's device.

In another embodiment, the capture agent may capture a screen shot of the password, code, etc. entry screen. In another embodiment, the capture agent may capture a gesture or pattern entered by the user.

In one embodiment, the application may automatically forward plain message 170, the key or other password information, etc. to archive server 180 for storage.

In another embodiment, the application may automatically send a copy of protected message 120 and key or other password information to archive server 180 for storage. This may be in place of, or in addition to, the sending of plain message 170 to archive server 180.

In one embodiment, safeguards may be put in place to prevent the password, key, etc. from unauthorized transmission. For example, safeguards may be put in place so that the third party application that may send the password, key, etc. to the archive server 180 for storage does not send the password, key, etc. to any unauthorized recipient.

Referring to FIG. 2, in another embodiment, system 200 may not include cloud storage. Instead, server 150 distributes protected message 120 to recipient 160 upon receipt or as appropriate.

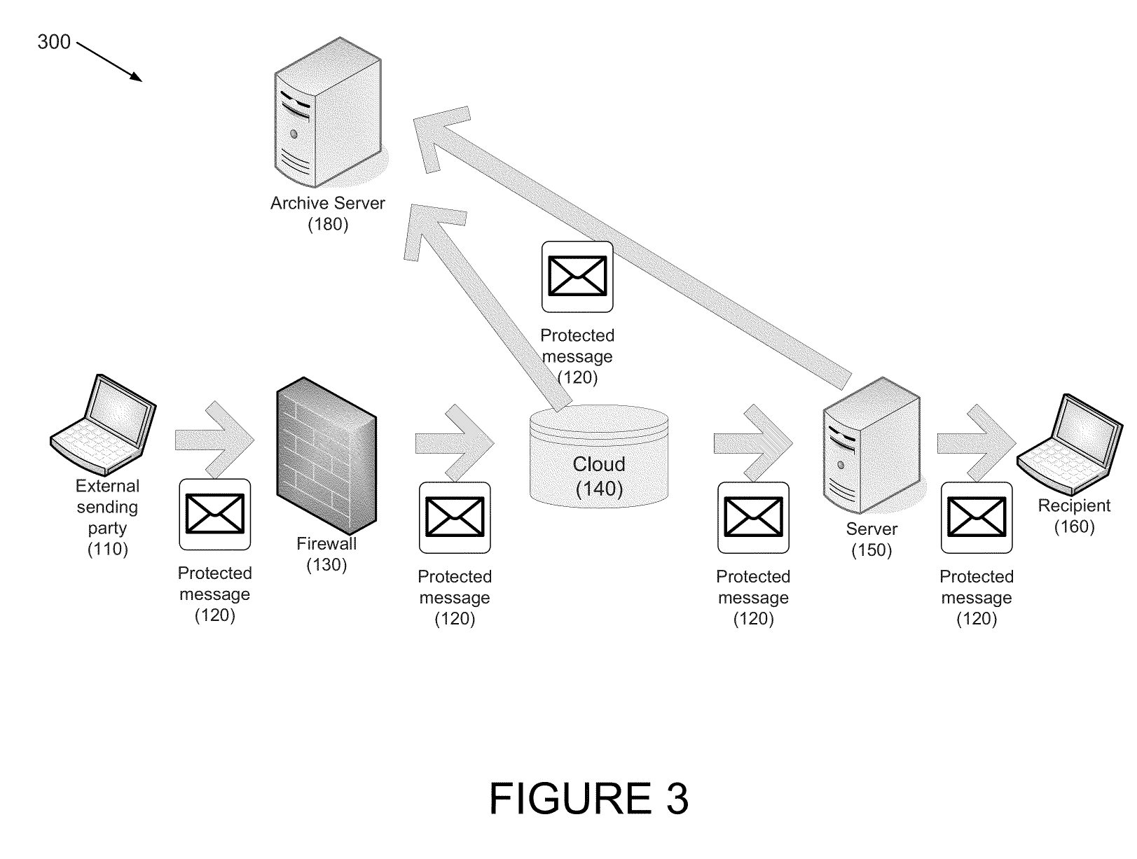

Referring to FIG. 3, in another embodiment, server 150 may provide a copy of protected message 120 to archive server 180. In still another embodiment, cloud storage 140 may provide a copy of protected message 120 to archive server 180. In still another embodiment, system 300 may not include cloud storage.

In one embodiment, archive server 180 may use access tools (e.g., decryption keys, passwords, etc.) that recipient 160 has used to open protected messages, and may apply those tools to protected messages as they are received. In another embodiment, archive server 180 may apply those tools to previously-archived messages.

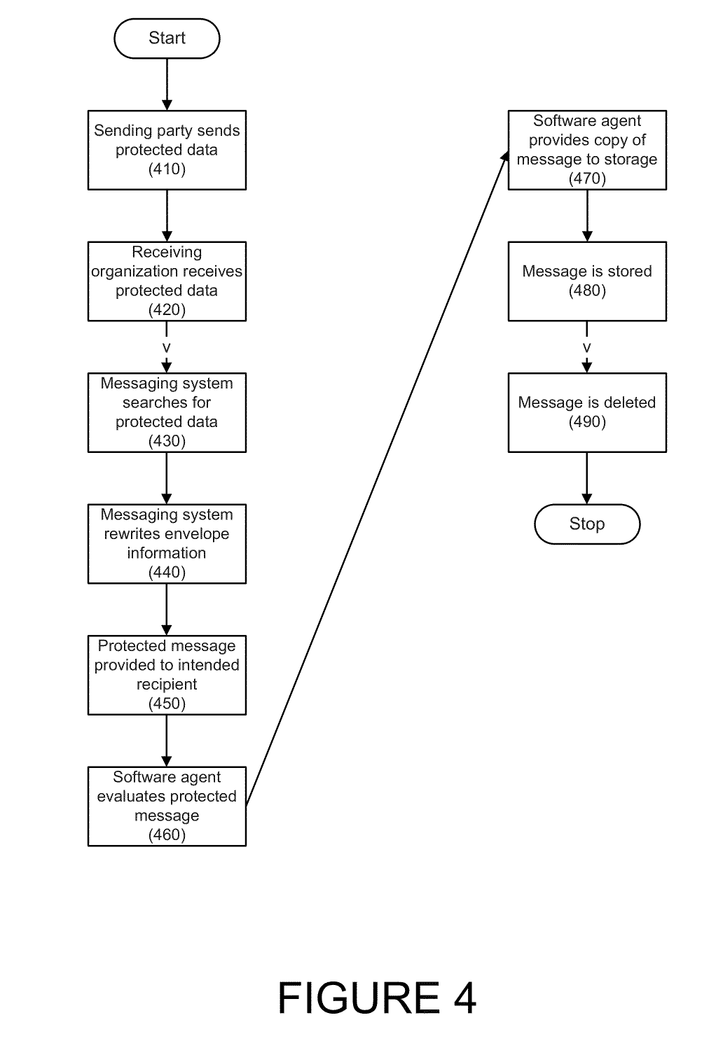

Referring to FIG. 4, a flowchart depicting a process for processing inbound communications according to one embodiment is provided. In step 410, a sending party may send protected data in a message, such as an email, file attachment, audio, video, picture, image, text, chat, SMS, etc. using any suitable protection mechanism, such as password protection, an encryption algorithm, a hashing algorithm, scrambling, transposition, etc. Any other suitable mechanism that may restrict outside access to data in the message may be used.

In step 420, the receiving organization may receive the protected message. In one embodiment, the receiving organization's messaging system (e.g., an inbound Mail Transfer Agent—MTA or cloud-based mail service (Symantec.Cloud, Postini, McAfee, Microsoft, Google, etc.) may process the inbound message.

In step 430, the messaging system may search the message for protected, encrypted, etc. data by searching for data that is unreadable. In one embodiment, the messaging system may search for specific file types, such as S/MIME, PGP, password-protected files, encrypted RAR, ZIP or WINZIP files, etc. In another embodiment, the messaging system may search for specific behavioral traits that are associated with protected data. For example, the messaging system may search for files or messages that cannot be inspected by machine or human (e.g., they do not contain human or machine-readable text); files or messages that have a particular source, destination, or content; files or messages that have redacted or obscured content; etc.

In step 440, the messaging system may re-write the message's envelope information to indicate that the message may contain protected data. For example, the messaging system may add a unique X-Header denoting that the email contains unreadable/unscannable data.

In another embodiment, the messaging system may mark or alter the message to indicate that the message may contain protected data. Other ways of indicating that the message may contain protected data may be used as necessary and/or desired.

In one embodiment, the protected message may simply be provided to the intended recipient without searching, scanning, or alteration.

In step 450, the protected message may be provided to the intended recipient.

In step 460, a software agent operating on the intended recipient's electronic device may read the envelope information and recognize that the message contains protected data. In one embodiment, the software agent may be a stand-alone agent. In another embodiment, it may be part of an anti-virus or data loss prevention (DLP) agent, or any other agent or code which is present on the endpoint device. In another embodiment, the software agent may be a script executing on the endpoint device. In still another embodiment, the software agent may be a part of the operating system executing on the endpoint device.

In step 470, the software agent may provide a copy of the message to storage after the intended recipient successfully accesses the message. Any suitable storage, such as an archive server, a database, a back-up system, etc. may be used.

In one embodiment, the message may be inspected for malware before sending. In another embodiment, the message may be inspected by the DLP agent before sending.

In one embodiment, the software agent may also provide the password, key, etc. that was used to access the message to storage. As discussed above, this may involve the use of a key stroke agent or logger.

In one embodiment, the password, key, etc. and/or the message may be protected, encrypted, etc. with a different password, key, etc. before being sent for storage.

In step 480, the message may be stored in a server. In one embodiment, both the protected message and the plain message are stored.

In another embodiment, the password, key, etc. may be stored. In one embodiment, the password, key, etc. may be stored with the protected message. In another embodiment, a separate database of passwords, keys, etc. may be maintained. In one embodiment, the passwords, keys, etc. may be referenced to, or associated with, the message recipient, sender, etc. for future attempts to access protected messages.

In step 490, the message may be deleted as necessary and/or desired. For example, the message may be deleted after a legally-required passage of time, in accordance with the organization's document retention policies, etc.

In one embodiment, only incoming messages that meet certain criteria may be archived. For example, messages intended for certain recipient(s), messages having certain subjects or contents, messages received during a certain time period, etc. may be archived. Other messages may bypass the archiving.

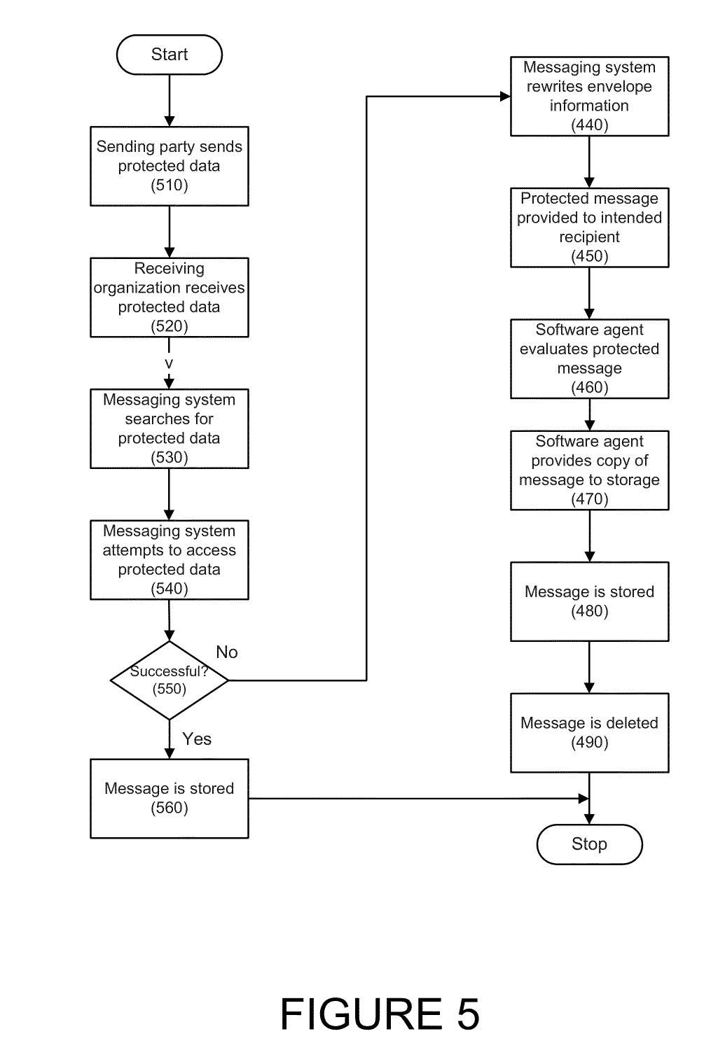

Referring to FIG. 5, a flowchart depicting a process for processing inbound communications according to another embodiment is provided.

In step 510, a sending party may protect data. This may be similar to step 410, above.

In step 520, the receiving organization may receive the protected message. This may be similar to step 420, above.

In step 530, the messaging system may search for protected, encrypted, etc. data by searching for data that is unreadable. This may be similar to step 430, above.

In step 540, the messaging system may attempt to access the protected data using passwords, keys, etc. that may be stored in a database of previously-applied passwords, keys, etc. In one embodiment, this access may be in a quarantine area, a sandbox, etc.

In one embodiment, the database may include a list of user-defined passwords, keys, etc. at the email ingress point or at the desktop.

If, in step 550, the access was successful, in step 560 the plain message may be sent to storage. In one embodiment, the protected message may also be stored. The success of the password, key, etc. may also be noted.

If, in step 550, the access was not successful, the protected message may be processed as described in steps 440-490, above.

In another embodiment, a method of processing outbound messages is provided. In general, the organization may control the tools by which its members, employees, etc. and the applications use to encrypt data and send messages from the organization.

In one embodiment, an organization may require that all messages leaving an organization are inspected for compliance with organizational data encryption policies before they are sent from the organization. The organization may also require that the encrypted copy be stored in accordance with organizational policies.

In still another embodiment, a copy of the non-encrypted message may be stored with, or instead of, the encrypted copy. Data regarding the encryption (e.g., type of encryption, date/time of encryption, who encrypted, etc.) may be stored.

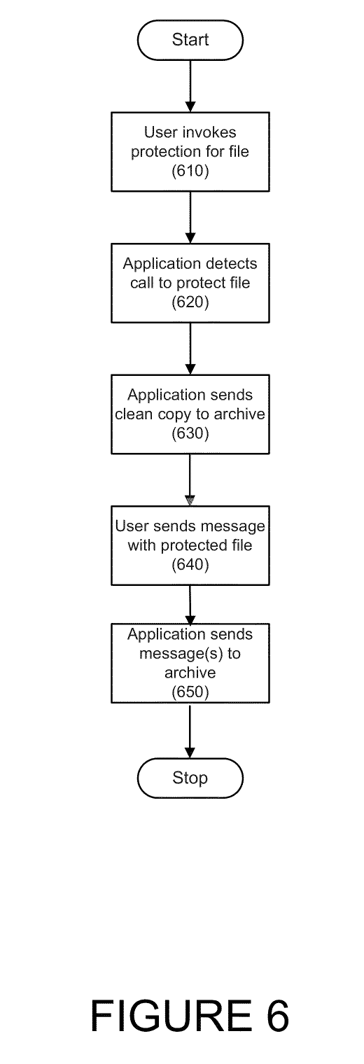

Referring to FIG. 6, a method of processing protected files is provided. In step 610, a user decides to encrypt, password protect, or otherwise restrict access to a file. In one embodiment, the file may be any sort of file, including documents, pictures, video, audio, data, etc.

In one embodiment, the user may invoke an application, program, etc. to encrypt, password protect, etc. the file. For example, the user may use WinZip, S/MIME (Secure/Multipurpose Internet Mail Extensions), an option to save a file with a password (e.g., Adobe Acrobat), PGP, etc. Any suitable application, program, etc. may be used.

In step 620, an application executing on the user's electronic device detects the call to encrypt, password protect, etc. the file. In one embodiment, the application may be a stand-alone application, or it may be part of another application. In another embodiment, the application may execute in the background and may not require any user intervention. In another embodiment, the application may be a script executing on the user's electronic device. In still another embodiment, the application may be a part of the operating system executing on the user's electronic device.

In step 630, the application may send a clean (e.g., not encrypted or protected) copy of the file to an archive for storage. In addition, the application may monitor the key, password, code, biometric, etc. that is used to encrypt, protect, etc. the file.

In step 640, the user may send a message containing the protected file. In one embodiment, the user may send the file by electronic mail. In another embodiment, the user may make the protected file available on a FTP site. In still another embodiment, the user may copy the protected file to a network location. In still another embodiment, the user may copy the protected file to an external memory source (e.g., flash memory, external hard drive, etc.).

In step 650, the application, or another application, may send a copy of the message containing the encrypted file to archive storage. In another embodiment, the application may send a clean copy of the file to archive storage. In still another embodiment, the application may send the encrypted file and the key/password/etc. to archive storage.

In one embodiment, the application may be used for users or files that meet certain criteria. For example, the application may only be active for certain individuals within the organization, with certain file types, during certain time frames, etc. In another embodiment, the application may be able to be “turned on or off” as necessary and/or desired.

In another embodiment, even if a file is not sent from the user, whenever the user encrypts or otherwise protects a file, a clean copy of that file may be saved to an archive. In one embodiment, the archive may be encrypted.

In one embodiment, the file may be decrypted, made available on a network, deleted, etc. when predetermined conditions are met, such as the passage of time, departure of a sender and/or recipient, closure of a deal, etc.

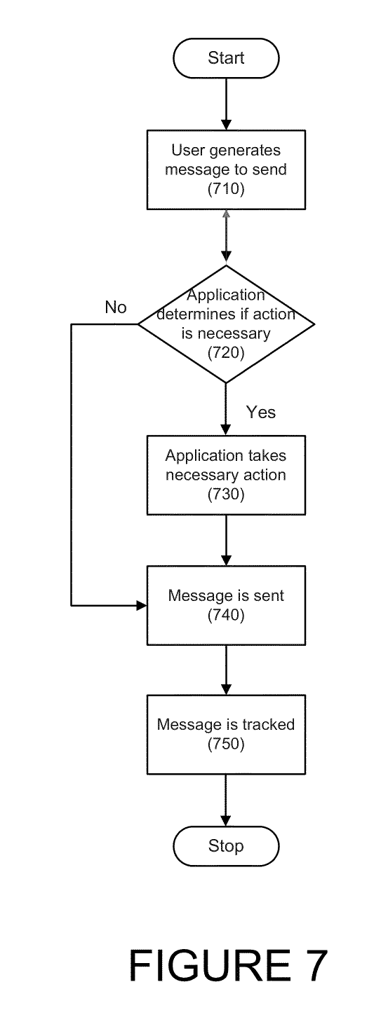

In another embodiment, an application may also determine which messages are to be encrypted. Referring to FIG. 7, a method for processing outbound messages is provided.

In step 710, a user generates a message to send to at least one recipient. The message may be, for example, an email, SMS, MMS, iMessage, etc. In one embodiment, the message may include a subject and body content, and may further include an attachment.

In step 720, an application executing on the user's electronic device evaluates the message to determine if it meets a predetermined criteria for encryption, password protection, etc. or archiving. In one embodiment, the application may evaluate the message to determine whether the sender of the message meets the criteria to have the message protected or archived. In another embodiment, the application may evaluate the message to determine whether at least one recipient of the message meets the criteria to have the message protected or archived. In still another embodiment, the application may evaluate the message to determine whether the content (e.g., the subject, body, and/or attachment(s), etc.) meets the criteria to have the message protected or archived. In still another embodiment, the application may evaluate the message to determine whether the timing of the message meets the criteria to have the message protected or archived. Other criteria may be evaluated and used as necessary and/or desired.

In one embodiment, the application may be a stand-alone application, or it may be part of another application. In another embodiment, the application may execute in the background and may not require any user intervention. In another embodiment, the application may be a script executing on the user's electronic device. In still another embodiment, the application may be a part of the operating system executing on the user's electronic device.

Next, in step 730, if the message is to be protected and/or archived, the application may take the appropriate action. In one embodiment, the application may call an encryption, password protection, etc. program to protect the message and/or attachment. The application may send a protected copy with a key/password, and/or a clean copy to the archive.

In another embodiment, the application may send a clean copy to the archive for storage.

In step 740, the message is sent to the recipient. In one embodiment, this may involve the messaging system sending the message outside the organization using known methods and techniques.

In one embodiment, in step 750, the message may be provided with a script, program, attachment, link, etc. for reporting that the file was read by a recipient, and the identity of the recipient. In one embodiment, digital rights management (DRM) functionality may be used. For example, once protected content from a message is received, the sender may be informed that the message was received. In another embodiment, the sender may be informed when the protected content is accessed in clear form (e.g., decrypted or the password, code, key, etc. was applied). In one embodiment, the telemetry of the file (e.g., the identity of the recipient, the recipient's IP address, the date and time of access, the number of attempts to access the protected data, etc.) may be reported. Other information may be provided as necessary and/or desired.

In one embodiment, the sender may be provided with a report after a predetermined passage of time, an event, etc. whether or not the protected content has been accessed or access has been attempted.

In one embodiment, the entry of the password, code, key, etc. may cause some of all of the telemetry of the file to be reported to the sender and/or the sender's organization.

In one embodiment, a program on the recipient's end (e.g., the decryption program, the operating system, the messaging system, etc.) may report the access or attempted access to the protected data.

The disclosure of U.S. Pat. No. 7,376,830, U.S. patent application Ser. No. 13/529,419, and U.S. patent application Ser. No. 13/492,126 are hereby incorporated, by reference, in their entireties.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ 8 operating system, Microsoft Windows™ 7 operating system, the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

I claim:

1. A method for processing inbound messages, comprising:
receiving a message containing protected content at an electronic device comprising at least one computer processor;
using the at least one computer processor, determining a manner in which unprotected content corresponding to the protected content is accessed by a user; and
using the at least one computer processor, automatically sending the unprotected content to a first storage location.

2. The method of claim 1, further comprising:
using the at least one computer processor, automatically sending the manner used to access the unprotected content to a second storage location.

3. The method of claim 2, wherein the first storage location and the second storage location are the same storage location.

4. The method of claim 1, further comprising:
using the at least one computer processor, automatically sending the message containing protected content to the first storage location.

5. The method of claim 1, wherein the manner comprises an application of a key.

6. The method of claim 1, wherein the manner comprises an entry of a password.

7. A method for processing inbound messages, comprising:
receiving an inbound message for a recipient;
determining, using at least one computer processor, whether the inbound message contains protected content;
using the at least one computer processor, marking the inbound message with an indication that the inbound message contains protected content; and
sending the marked received message to an electronic device associated with the recipient.

8. The method of claim 7, wherein the step of marking the inbound message comprises:
using the at least one computer processor, rewriting envelope information for the inbound message.

9. The method of claim 7, wherein the received message comprises at least one of an email, a file attachment, audio, picture, image, video, text, chat, and SMS.

10. The method of claim 7, further comprising:
receiving, from the electronic device associated with the intended recipient, a message containing non-protected content corresponding to the protected content; and
providing the message containing non-protected content corresponding to the protected content to a first storage location.

11. The method of claim 7, further comprising:
providing the inbound message containing protected content to a second storage location.

12. The method of claim 7, further comprising:
receiving, from the electronic device associated with the intended recipient, a tool used to access the non-protected content from the protected content; and
providing the tool to a third storage location.

13. The method of claim 12, wherein the access tool is one of a password and a key.

14. A method for processing inbound messages, comprising:
receiving an inbound message including protected content;
using at least one computer processor, applying a tool to the inbound message to access non-protected content corresponding to the protected content; and
providing the non-protected content to a first storage location.

15. The method of claim 14, further comprising:
providing the non-protected content to the intended recipient

16. The method of claim 14, further comprising:
providing the inbound message to the intended recipient

17. The method of claim 14, further comprising:
providing the tool to a second storage location.

18. The method of claim 14, further comprising:
providing the received message containing protected content to a third storage location.

19. The method of claim 14, wherein the access tool is one of a password and a key.

20. The method of claim 14, wherein the tool is retrieved from a database comprising a plurality of tools.
